(19) United States
(12) Patent Application Publication
(10) Pub. No.: US 2014/0278516 A1
(43) Pub. Date: Sep. 18, 2014

(54) METHOD AND SYSTEM FOR RAPID AND SECURE APPROVAL AND RELEASE OF IMPLANTABLE PRODUCTS

(71) Applicant: TODD COHEN, Port Washington, NY (US)

(72) Inventor: TODD COHEN, Port Washington, NY (US)

(21) Appl. No.: 14/218,652

(22) Filed: Mar. 18, 2014

Related U.S. Application Data
(60) Provisional application No. 61/788,771, filed on Mar. 15, 2013.

(51) Int. Cl. G06Q 50/22; G06Q 30/04; G06Q 30/00

(52) U.S. Cl. CPC G06Q 50/22; G06Q 30/018; G06Q 30/04
USPC 705/2

(57) ABSTRACT

A system and method for ensuring compliance with National Coverage Determination Registry guidelines regarding the implantation of implantable medical devices which comprises: uploading source documentation through a computerized system to a third party evaluation; comparison of said source documentation with criteria established by the National Coverage Determination Registry (NCDR) to determine whether or not there has been compliance; and if there has been compliance, issuing approval documentation.

### CROSS-REFERENCE TO RELATED APPLICATION

The present application is based upon and claims the benefit of the filing date of U.S. Provisional Patent Application Ser. No. 61/788,771, filed Mar. 15, 2013, incorporated herein by reference in its entirety.

### FIELD OF THE INVENTION

The invention described herein relates to the release of medical products to patients. More particularly, this invention relates to a cost-effective, rapid, and secure method and system for obtaining regulatory or medical organization approval and then releasing implantable medical products. An additional more comprehensive system is also provided for tracking operator, institution, and implant performance as well as quantifying procedural outcomes for value based purchasing. Further, the system can assure compliance not only with implant guidelines but also with warranty/partial warranty payments to institutions that also receive reimbursement for the procedure from federal agencies such as Medicare and Medicaid. Bar coding or data matrix coding of implantable products and source data are provided to enable secure uploading and tracking of patient specific information.

### BACKGROUND OF THE DISCLOSURE

Pyxis MedStation® systems from CareFusion 303, Inc., San Diego, Calif., operate by storing medical products such as pharmaceuticals and releasing them as needed for a particular patient. The patient's identification information is inserted, and the product is released, much like a vending machine.

Implantable products such as pacemakers and defibrillators are heavily regulated, and defibrillators have been the subject of a Department of Justice investigation regarding implantation outside the guidelines of a National Coverage Determination (NCD) as issued by the Center for Medicare Services (CMS). Presently, devices are implanted following the guidelines, and some institutions even require a sign off sheet to assure that these guidelines have been satisfied. However, this is effectively an honor system without oversight, and the veracity of the information is only tested if and when there is an audit of these cases. In addition, there is a post hoc system (following the implant) for acquiring data required by the National Coverage Determination Registry (NCDR). But, such a registry is after the fact of the implant, whether appropriate or inappropriate. Uploading of data in the registry may occur well after the implant (weeks or months) and provides no protection to the institution and/or operator against fraud and abuse as defined by the federal government. Therefore, there is a need for an upfront, real time system for evaluating actual source data, certifying said data, and only releasing appropriate and qualified secure or stored medical implant products once all of this data is provided using some form of secure release method. The system may also use bar coding and or data matrix codes or some other secure coding to track patient specific data as well as outcomes.

Also, manufacturer warranty payments to institutions have also been the subject of fraud and abuse investigations, and institutions are required to have policies so as to not receive payments from a manufacturer from a failed product warranty and collect federal payments for a new device in full from CMS. By use of a bar code, data matrix code, or some other coding system, warranty payments could be centralized and prevent against so-called “double dipping” and protect a health institution from fraud and abuse. A system and method are described which in essence provides cradle to grave private and secure tracking of implantable material approval, performance, failure, warranty information, outcome data, and compliance and would be useful for value based purchasing.

### OBJECTS OF THE INVENTION

It is an object of the invention to provide a system for remotely evaluating source data for approval of implantation of a medical device.

It is also an object of the invention to provide a method for remote evaluation of source data for approval of implantation of a medical device.

It is a further object of the invention to provide a cost-effective, rapid, and secure method and system for obtaining regulatory or medical organization approval and then releasing implantable medical products.

It is a yet further object of the invention to provide an additional more comprehensive system for tracking operator, institution, and implant performance as well as quantifying procedural outcomes for value-based purchasing.

It is a yet further object of the invention to provide a system that can assure compliance not only with implant guidelines but also with warranty/partial warranty payments to institutions that also receive reimbursement for the procedure from federal agencies such as Medicare and Medicaid.

It is a yet further object of the invention to provide bar coding or data matrix coding of implantable products and source data as a means to securely upload and track patient specific information.

It is a yet further object of the invention to provide a method and system to utilize bar code, data matrix code, or some other coding system to centralize warranty payments to prevent “double dipping.”

It is a yet further object of the invention to provide a method and system to utilize bar code, data matrix code, or some other coding system to protect a health institution from fraud and abuse.

It is a yet further object of the invention to provide a system and method which essentially provides cradle to grave private and secure tracking of implantable material approval, performance, failure, warranty information, outcome data, and compliance and would be useful for value based purchasing.

These and other objects of the invention will be more apparent in the description below.

### SUMMARY OF THE INVENTION

According to the invention, a method and system are provided for the remote evaluation of source data and approval or disapproval of implantation of an implantable medical device. An aspect of this invention also comprises creation of a distribution system for the implantable device, such as a vending type machine system which stores implantable medical devices such as pacemaker and defibrillator products that are dispensed only after determination that either local or national coverage or guidelines have been followed. The system provides an automated algorithm and method of scanning actual source documents, such as echo reports, cardiac catheterization reports, patient labs, and inducible arrhythmias such as ventricular tachycardia, and submitting the data directly, prior to release of the device from the machine.

### DETAILED DESCRIPTION OF THE INVENTION

There are patents related to electronic or computerized submission of data required to pre-approve or authorize a prescribed drugs or even a procedure. There are however, no prior art related to a system and method to help the Federal Government and in particular the Center for Medicare and Medicaid Services control costs related to implantable heart rhythm devices (pacemakers and defibrillators) as dictated by their National Coverage Determinations (NCD) which specifically list the only covered indications for hospitals, institutions, and operators in order to get paid for these services. There is no preauthorization procedure and hospitals, institutions, and operators remain at risk for fraud and abuse for any implants performed that do not specifically meet the NCD criteria. First these implants are very expensive and costly to the government body. Second they can be costly to a hospitals, institutions, and operators with respect to compliance issues when said implants are audited by a Federal Body, Agency, etc and found to be implanted outside the NCD and categorized as Fraud and Abuse. Said implant may make a hospitals, institutions, and operators liable for up to triple damages for said implant if that is the case.

Therefore, a method, system, and program named Device Manager has been developed as a tool that could be used by the Federal government to force each hospitals, institutions, and their operators to comply with the National Coverage Determination. Said program and system has broken down each of the NCD criteria for pacemakers and defibrillators into required criteria baskets. The actual source data and documents required to substantiate an NCD is uploaded by an operator and/or their team and is independently reviewed PRIOR to any pacemaker or defibrillator implant. Once all the appropriate data is in put it is sent for review by an independent team. That team will review said implant and issue an APPROVAL or DENIAL. If APPROVED, a secure code is issued to the hospitals, institutions, and/or operators which can release the implantable material for the implant. Said material may be stored either on or of site in a secure, organized easily accessible manner, but only can be released after the presence of this issued code. The storage system could be a machine which could stack the coded implant material and release it according to the issued approval code. The code itself may be a secure personal identification number in which health care information related to said implant is tracked from prior to the procedure through the rest of the patient's device follow-up and events and death. Source data from said code could be linked to the NCDR (National Coverage Determination Registry) and provide actual source data linkage rather than a check list which is how this post doc required NCDR data base currently functions.

The Device Manager system could give the Federal government a very specific secure system to control health care costs related to said implantable devices as dictated by the NCD. It would minimize unnecessary implants and prevent fraud and abuse. The system would also provide hospitals, institutions, and operators with a excellent compliance tool (Device Manager) with a means of upfront following the NCD and storing said associated source data information prior to the implant. Data as specific as whether the patient him or herself signed the informed consent and an expected longevity of greater than one year would need documentation prior to any defibrillator implant. All associated rhythms strips, electrophysiology reports, electrocardiograms, progress notes, lab values, histories and/or consults, and actual independent left ventricular ejection fraction records (echocardiograms, angiograms, and/or nuclear studies) would all need to be uploaded and approved as meeting NCD criteria prior to the implant. Actual rhythm strips and their interpretation together with correlation to symptoms would also need to be uploaded for pacemaker appropriate indications.

Each institution would have an administrative over-ride to adjudicate and or approve of DENIED implants without billing CMS (exists in the Device Manager system). The Device Manager system could be managed and offered directly by CMS or alternatively a third party service either independently or linked to a liability insurance product to provide an institution with compliance and limited exposure in the case of a federally issued NCD related audit.

There is a need for an upfront, real-time system for evaluating actual source data, certifying said data, and only releasing appropriate and qualified secure or stored medical implant products once all of this data is provided, using some form of secure release method. The system may also use bar coding and/or data matrix codes or some other secure coding to track patient specific data as well as outcomes.

In addition, manufacturer warranty payments to institutions have also been the subject of fraud and abuse investigations, and institutions are required to have policies so as to not receive payments from a manufacturer for a failed product warranty and then collect federal government payments for a new device in full from CMS. By use of a bar code, data matrix code, or some other coding system, warranty payments could be centralized to prevent against so-called “double dipping,” and to protect a health institution from fraud and abuse. A system and method are described which essentially provides cradle to grave private and secure tracking of implantable material approval, performance, failure, warranty information, outcome data, and compliance and would be useful for value-based purchasing.

In an embodiment of the invention, a system comprises an input for inputting original source information regarding a patient's medical history and other source data, an input for inputting standards criteria regarding the requirements for use or implanting implantable medical devices, and a processor for remotely evaluating the inputted medical information, comparing that information against the criteria, and, if the criteria are met, issuing an approval.

In another embodiment of the invention, a method comprises inputting a patient's medical history and other source data into a remote processor, inputting standards criteria for implanting an implantable medical device into the remote processor, and, if the criteria are met, issuing an approval.

In another embodiment of the invention, the implantable medical device is a permanent pacemaker or an implantable defibrillator.

In another embodiment of the invention, actual source data is submitted via mail, electronically, digitally, scanned, or via some other means and evaluated and approved via either a computerized means and/or human means and based on said data an approval is generated either directly or indirectly to provide for the release of implantable medical devices or materials to be available for the procedure.

In another embodiment of the invention, the approval results in the release of an implantable medical device or materials from a secure machine having implantable medical devices or materials to dispense and the ability to charge the patient accordingly.

In another embodiment of the invention, the approval results in release of an implantable medical device or materials from a secure regulatory service such as the federal government or a third party such as a health insurance company, hospital/medical system, or manufacturer having implantable devices or materials to dispense and the ability to charge the patient accordingly.

In another embodiment of the invention, approval results in issuance of a ticket and/or secure method of accessing the secure implantable medical device or material once approved, and once the secure method is entered into said system, releasing the implantable medical device or material.

In another embodiment of the invention, the remote evaluation and review is a service provided by the federal government or a non-governmental third party such as a health insurance company, a hospital/medical system, or a manufacturer which actually holds and/or controls the release of the implantable products.

In another embodiment of the invention, if permission is denied for dispensing an implantable medical device or material, the processing entity provides an alternative approach of oversight, such as discussion with a medical director to decide on the appropriateness of an implantable product based on source data.

In another embodiment of the invention, the processing entity approves the dispensing of wearable cardioverter defibrillators to patients who may be at risk for sudden death but do not qualify for such an implantable product.

In another embodiment of the invention, the system and method permit an expeditious and real-time evaluation of source data such as ECG, holter monitor strips, telemetry strips, event recorder or loop recorder strips, conduction disease source data as documented during electrophysiology study, induced arrhythmia source data as documented during electrophysiology study, lab work, cardiac catheterization, nuclear cardiology, CT angiography and cardiac MRI, and/or echocardiogram to promptly approve or reject implantation of a heart rhythm control system.

In another embodiment of the invention, the system is computerized and performed in the cloud with human oversight.

In another embodiment of the invention, the system performs and the method is carried out entirely without human oversight.

In another embodiment of the invention, the system and method provide an alternative to rejected cases that fail to qualify for an implantable device by providing a method to adjudicate and argue the rejection.

In another embodiment of the invention, the system and method provide an alternative to rejected cases that fail to qualify for an implantable device by providing a wearable cardioverter defibrillator to protect the patient during a period of review.

In another embodiment of the invention, the system and method comprise applying regulatory criteria to an approval algorithm which comprises the submission of pre-specified information/source data electronically to be evaluated remotely and approved, wherein the approval process provides a means of securely releasing implantable material for the implant procedure in a timely fashion, and a method of disputing any rejections of said implant procedure.

In another embodiment of the invention, a secure machine stores implantable medical devices and materials and only releases the implantable products if approved by a regulatory algorithm (computerized and/or human) which would provide a secure method to release the implantable products.

In another embodiment of the invention, the approval and release of a wearable cardioverter defibrillator is based on pre-specified regulatory criteria.

In another embodiment of the invention, a system of securely and privately evaluating patient specific source data to control the storage and release of implantable medical devices or materials is based upon regulatory criteria utilizing bar codes, data matrix codes, or the like.

In another embodiment of the invention, a system of securely and privately controlling the release of implantable medical devices or materials for all qualified implants in real time, wherein the system uses bar codes, data matrix codes, or some other coding system to track patient specific information as obtained from source data to release coded implantable medical devices or materials to the operator.

In another embodiment of the invention, a system is also able to track operator, institution, and implantable product performance post implant by uploading source data documenting any and all procedural complications and/or equipment failure (including any and all implant equipment). Source data would be submitted to the appropriate agencies (for example, Maude Database, U.S. Food and Drug Administration, and manufacturer) to track implantable product performance and determine whether a safety advisory and/or recall is necessary.

In another embodiment of the invention, according to the system and method the data would be used in determining whether the failure of an implantable product is covered in part or in full by a manufacturer's warranty and assuring that a hospital or institution does not get paid by both insurance and the manufacturer (i.e., double dipping) and would assure an institution's compliance with respect to warranty coverage and payment.

In another embodiment of the invention, the data would also be useful in quantifying an individual and/or medical institution/health system's outcomes for value-based purchasing.

In another embodiment of the invention, a system and method of securely protecting a medical institution with respect to compliance as it relates to the appropriateness of implantable medical devices, tracking any implantable medical device and/or operator failure, providing outcome data that are implant product related (types of failure modes), operator-related (such as number and types of procedures and specific complications), and/or institution-related (such as number and types of procedures and specific complications), and assuring that any warranty payments are appropriate based on state and federal requirements.

1. A method for assuring compliance with respect to the National Coverage Determination implant indication criteria for implantable medical devices or products such as pacemakers and defibrillator, as issued by the Center for Medicare Service, comprising
inputting demographic data for a patient into a computerized system or processor for enrolling and tracking each subscribed institution and each implanting operator or provider to enroll the patient with regard to possible implantation of an implantable medical product;
quantifying each National Coverage Determination implant indication into a preset source document basket which entirely satisfies each National Coverage Determination implant indication criteria;
uploading source data documents and storing said documents in each said basket for review and compliance approval prior to said implant;
independently reviewing and evaluating source documents in said baskets and determining whether each source document meets corresponding implant indication criteria as determined by the National Coverage Determination;
approving or disproving a proposed implant as meeting all of said implant indication criteria and submitting said approval for secure release of implantable material for the patient; and
generating a secure code for release of said implantable product for the approved implant procedure.

The method of claim 1 which comprises an additional step of keeping implantable medical devices at a large storage system with secure access for systematic and release of said implantable medical devices based on the secure generated access code.

In another embodiment of the present invention, the source data comprise one or more criteria selected from the group consisting of electrocardiograms, ejection fraction reports, consent forms attesting to the patient's own signature, laboratory results proving irreversible cause of the arrhythmia, electrocardiographic strips and electrophysiology reports, and history/progress notes/consults.

In another embodiment of the present invention which also includes a procedure for adjudicating cases that fail to satisfy the National Coverage Determination implant indication criteria.

In another embodiment of the present invention which also includes a procedure for authorizing use of a wearable cardioverter defibrillator to protect a patient from sudden death during adjudication of a case that does not readily meet the National Coverage Determination implant indication criteria

In another embodiment of the present invention which also comprises long-term storage of said data in case of an audit by Medicare, Medicaid, a health insurance company, or some other reviewing body

In another embodiment of the present invention which is used by the federal government as a cost containment measure by controlling use of an expensive implantable product in a health system with limited resources.

In another embodiment of the present invention which is used by an institution as a compliance tool to prevent exposure of the institution to fraud and abuse.

In another embodiment of the present invention which is coupled to a liability umbrella coverage to minimize institutional exposure to fraud and abuse.

In another embodiment of the present invention which an authorized institutional administrator has the ability to override the decision of a reviewer to approve an implantable product and to generate a secure code for release of the implantable medical product for the safety of the patient without billing Medicare or Medicaid or any associated Health Insurance.

In another embodiment of the present invention wherein any quantifiable fields can be linked to the National Coverage Determination Registry as they relate to relevant implantable products.

In another embodiment of the present invention with respect to the National Coverage Determination implant indication criteria for implantable devices such as pacemakers and defibrillators as issued by the Center for Medicare and Medicaid Services, comprising
a computerized system or processor for enrolling and tracking each subscribed institution and each implanting operator or provider;
a source of demographic data to be inputted to enroll each proposed patient for an implant;
means for quantifying each National Coverage Determination implant indication criteria into preset source document baskets which entirely satisfies each National Coverage Determination implant indication criteria;
means for uploading said source data to the computerized system or processor to store said documents into said baskets for review and compliance approval prior to said implant;
means to independently review and evaluate said baskets and determine whether the source documents meet the National Coverage Determination implant indication criteria;
means for a reviewer to approve or disprove said implant as meeting all of the implant indication criteria and to submit said approval for secure release of implantable medical product for the patient; and
means to generate a secure code for release of said implantable product for the approved implant procedure.

In another embodiment of the present invention which also comprises a large storage system for systematically keeping implantable medical products with secure access and release of said implantable medical products based on the secure generated access code.

In another embodiment of the present invention which also comprises a procedure or means to use a wearable cardioverter defibrillator to protect a patient from sudden death while adjudicating cases that do not readily meet the National Coverage Determination implant indication criteria.

In another embodiment of the present invention which also comprises long-term storage of said data in case of an audit by Medicare, Medicaid, a health insurance company, or some other reviewing body.

In another embodiment of the present invention which is coupled to a liability umbrella coverage in order to minimize institutional exposure to fraud and abuse.

In another embodiment of the present invention where any quantifiable fields can be linked to the National Coverage Determination Registry as they relate to relevant implantable products.

In another embodiment of the present invention ensuring compliance with National Coverage Determination Registry guidelines regarding the implantation of implantable medical devices which comprises:
uploading source documentation through a computerized system to a third party evaluation;
comparison of said source documentation with criteria established by the NCDR to determine whether or not there has been compliance; and
if there has been compliance, issuing approval documentation.

In another embodiment of the present invention wherein actual source data is submitted via mail, electronically, digitally, scanned, or via some other means and evaluated and approved via either a computerized means and/or human means and based on said data an approval is generated either directly or indirectly to provide for the release of implantable products to be available for said procedure.

In another embodiment of the present invention wherein the system and approval provides a method for release of said equipment from a secure machine having implantable products in order to dispense and charge the patient accordingly.

In another embodiment of the present invention wherein the system and approval provides a method for release of said equipment from a secure regulatory service such as the government, third party, health insurance companies, hospital/medical system, or manufacturer having implantable products in order to dispense and charge the patient accordingly.

In another embodiment of the present invention wherein the system provides a ticket and/or secure method of accessing the secure implantable material once approved, and once the secure method is entered into said system, releasing the implantable material.

In another embodiment of the present invention wherein said system is a service provided by the government, third party, health insurance companies, hospital/medical system, or manufacturer which actually holds and/or controls the release of said products.

In another embodiment of the present invention denying permission for dispensing a medical implantable product and providing an alternative approach of oversight, such as discussion with a medical director in order to decide on the appropriateness of an implantable product based on source data.

In another embodiment of the present invention approving the dispensing of wearable cardioverter defibrillators to patients who may be at risk for sudden death but do not qualify for such an implantable product.

In another embodiment of the present invention which permits an expeditious and real-time evaluation of source data such as an ECG, holter monitor strips, telemetry strips, event recorder or loop recorder strips, conduction disease source data as documented during electrophysiology study, induced arrhythmia source data as documented during electrophysiology study, lab work, cardiac catheterization, nuclear cardiology, CT angiography and cardiac MRI, and/or echocardiogram in order to promptly approve or reject implantation of a heart rhythm control system.

In another embodiment of the present invention wherein the system is computerized and performed in the cloud with human oversight.

In another embodiment of the present invention wherein the system is entirely performed by human oversight.

In another embodiment of the present invention provides an alternative to rejected cases that fail to qualify for an implantable device and provides a method to adjudicate and argue the rejection and/or provides a method such as a wearable cardioverter defibrillator in order to protect the patient during a period of review.

In another embodiment of the present invention applying regulatory criteria to an approval algorithm which consists of the submission of pre-specified information/source data electronically to be evaluated remotely and approved, wherein the approval process provides a means of securely releasing implantable material for the implant procedure in a timely fashion, and a method of disputing any rejections of said implant procedure.

In another embodiment of the present invention which provides a secure machine like a Pyxis MedStation machine for storing all implantable products and only releasing the products if approved by a regulatory algorithm (computerized and/or human) which would provide a secure method to release said implantable products.

In another embodiment of the present invention which provides for the approval and release of a wearable cardioverter defibrillator based on pre-specified regulatory criteria.

In another embodiment of the present invention of securely and privately evaluating patient specific source data in order to control the storage and release of implantable materials based on regulatory criteria utilizing bar codes or data matrix codes or the like.

In another embodiment of the present invention of securely and privately controlling the release of implantable materials for all qualified implants in realtime, wherein the system uses bar codes, data matrix codes, or some other coding system to track patient specific information as obtained from source data in order to release coded implantable material to the operator.

In another embodiment of the present invention which also is able to track operator, institution, and implantable material performance post implant by uploading source data documenting any and all procedural complications and/or equipment failure (including any and all implant equipment), Source data would be submitted to the appropriate agencies (Maude Database, U.S. Food and Drug Administration, and manufacturer) in order to track implantable product performance and determine whether a safety advisory and/or Recall is necessary.

In another embodiment of the present invention wherein the data would be used in determining whether the failure of said implant is covered by a manufacturer's warranty (in part or in full) and assuring that a hospital or institution does not get paid by both insurance and the manufacturer (i.e., double dipping) and would assure an institution's compliance with respect to warranty coverage and payment.

In another embodiment of the present invention wherein the data would also be useful at quantifying an individual and/or medical institution/health system's outcomes for value based purchasing.

In another embodiment of the present invention of securely protecting a medical institution with respect to compliance as it relates to the appropriateness of medical implants, tracking any device and or operator failure, providing outcomes data that are implant product related (types of failure modes), operator related (such as number and types of procedures and specific complications), and/or institution related (such as number and types of procedures and specific complications), and assuring that any warranty payments are appropriate based on state and federal requirements.

In another embodiment of the present invention a system for collecting national registry data in conjunction with an existing electronic medical records system as patient care is conducted, comprising: a database that stores a plurality of variables per patient for one or more national registries; and a processor in communication with the database that in order to simultaneously collect data required to populate one or more variables of one or more national registries and data needed to populate a clinical note medical record of an existing electronic medical records system as a patient is being seen by a healthcare provider, provides a user interface that requests clinical note data from the healthcare provider and displays on the user interface at the same time both the data required to populate one or more variables of the one or more national registries and the data needed to populate a clinical note medical record of an existing electronic medical records system, receives the clinical note data entered by the healthcare provider for the patient from the user interface, determines that the clinical note data being entered is similar to the data required to populate one or more variables of the one or more national registries and prompts the healthcare provider to enter the data required to populate one or more variables of the one or more national registries, and automatically and at the same time stores the entered clinical note data needed to populate a clinical note medical record in the existing electronic medical records system for the patient and stores the entered clinical note data required to populate one or more variables for the patient for the one or more national registries in the database.

In another embodiment of the present invention a computer program product, comprising a non-transitory and tangible computer-readable storage medium whose contents include a program with instructions being executed on a processor so as to perform a method for collecting national registry data in conjunction with an existing electronic medical records system as patient care is conducted, the method comprising: providing a system, wherein the system comprises one or more distinct software modules, and wherein the distinct software modules comprise a user interface module and a storage module; in order to simultaneously collect data required to populate one or more variables of one or more national registries and data needed to populate a clinical note medical record of an existing electronic medical records system as a patient is being seen by a healthcare provider, providing a user interface that requests clinical note data from the healthcare provider and displaying on the user interface at the same time both the data required to populate one or more variables of one or more national registries and the data needed to populate a clinical note medical record of an existing electronic medical records system; receiving the clinical note data entered by the healthcare provider for the patient from the user interface using the user interface module; determining that the clinical note data being entered is similar to the data required to populate one or more variables of the one or more national registries and prompting the healthcare provider to enter the data required to populate one or more variables of the one or more national registries; and automatically and at the same time, storing the entered clinical note data needed to populate a clinical note medical record in the existing electronic medical records system for the patient and storing the entered clinical note data required to populate one or more variables for the patient for the one or more national registries in the database using the storage module.

Within a pre-specified time, if the appropriate criteria are identified, a certificate (or ticket or code) will be generated with a code which if inserted/scanned/or entered into a device storage machine (like a Pyxis MedStation machine) or a holding service such as a regulatory body, third party, insurance agency, manufacturer, or hospital service that will allow the operator to select the implantable pulse generator and leads required for the procedure.

The purpose of the system described herein would be to allow medical systems (hospitals/health systems) prompt and precise control over expensive implantable materials in a timely fashion, and to protect hospitals and operators from the potential for inappropriate or perceived inappropriate implantation of these devices. Such systems may help control the cost of health care and assure appropriate utilization of expensive implantable material.

It is within the scope of the invention that, for borderline cases, there will be a method and time provided to adjudicate these cases, especially if they are elective. A method of requesting additional information and protecting the patient from the risk of sudden cardiac death with an approval of a wearable cardioverter-defibrillator is also provided for questionable/uncertain cases, which may be under dispute. The latter system could protect potential patients at risk for sudden death while such a more laborious process occurs. Non-elective denied cases could be discussed with one or more of the services directors after submission of source material.

Any and all approvals should occur in as close to real time so as not to delay needed life giving implants.

Alternative certification of wearable cardioverter-defibrillator products could also be released based on the source data in a similar manner. The wearable cardioverter-defibrillator could also be approved on a short-term basis to tide over any delays in the approval process of patients who may be borderline for a implantable defibrillator implant, while decisions are adjudicated.

The following document is perhaps a more precise method in which the submission, scanning/uploading of source data, and approval/denial/adjudication process may occur for both implantable pacemakers and implantable defibrillators.

Secure Upload Method to Authorize Release of Implantable Device Products

The Following Information Must Be Uploaded, Scanned, and/or Certified. Bar Coding/Data Matrix Coding of Patient Identification and Providing of Source Documentation is Required prior to Authorization and Implantable Product Release to the Provider.

Baseline Information Regardless of Device/System

Patient's Full Name and Date of Birth

Provider's Full Name and Provider Number

Click on Requested Product: Pacemaker
i. Defibrillator
ii. Wearable Defibrillator

Pacemaker:

Select Indication: Approved National Coverage List is Provided and Specific Indication Must Be Selected

Upload Source Material Documenting Said Indication (Include any History, Consults, ECGs, Telemetry Strips, Holter Monitors, Event Recorder or Loop Recorder, etc.)

Upload Source Material Documenting the correlation of Symptoms to Bradycardia (Actual source material and strips with symptoms documented at the time of arrhythmia).

Upload Source Material From any Electrophysiology Study including report and actual intracardiac recordings which demonstrate the degree and level of Sinus Node Dysfunction, AV Nodal Disease, and/or His-Purkinje Disease.

Upload Source Material Supporting Dual Chamber Device:
i. Young and Active
ii. Congestive Heart Failure
iii. Pacemaker Syndrome
iv. Drop in Blood Pressure During Ventricular Pacing (Strips and actual blood pressures must be provided)—the latter could be performed and entered during an approved pacemaker implant procedure.

Upload source interrogation data documenting existing systems malfunction, end of life status, patient's pacemaker dependency, underlying rhythm and need for replacement.

Please provide a description of any extenuating circumstances that explain the rationale for the specific request.

Upload said data and the operator needs to certify the request for the release of said implantable pacemaker implantable material.

Defibrillator:

Select Indication: Approved National Coverage List is Provided and Specific Indication Must Be Selected

Upload Source Material Documenting Said Indication (Include any History, Consults, ECGs, Telemetry Strips, Holter Monitors, Event Recorder or Loop Recorder, etc.)

Upload Source Material Documenting Any Arrhythmia, original diagnosis date and treatments of congestive heart failure including optimal medical therapy duration, original diagnosis and treatment of myocardial infarction, date and treatment of any coronary artery bypass surgery or percutaneous coronary intervention, documentation for primary prevention defibrillator that the myocardial infarction has been at least 40 days from implant and that coronary artery bypass surgery or percutaneous coronary intervention has been at least 90 days with a repeated source documented left ventricular ejection which satisfies the NCD criteria (Actual source material and strips with symptoms documented at the time of arrhythmia).

All initial Primary and Secondary Defibrillator Implants (including Biventricular Defibrillator Implants) require proof that the patient is not demented by source documentation and is capable and has signed informed written consent for said device.

Primary Prevention Defibrillator post myocardial infarction must document persistent left ventricular ejection fraction of less than or equal to 30 percent after 40 days following myocardial infarction or at least 90 days after coronary artery bypass surgery or percutaneous intervention in order to qualify (source data of repeat ejection fraction must be uploaded).

Primary Prevention Defibrillator post diagnosis and treatment of New York Heart Association Chronic Systolic Congestive Heart Failure Class II to III requires an ejection fraction less than 36 percent which persists following treatment with optimal medical therapy for at least three months. Source data must document the time of diagnosis of congestive heart failure proof of classification following optimal medical therapy and persistence of classification and ejection fraction criteria following at least three months of therapy.

Proof of Familial Sudden Death Condition with Genetic Testing and/or documented family history and/or documented imaging studies and diagnostic studies documentic inherited or congenital condition which places patient at risk for requiring an implantable defibrillator. Conditions include: 1. Hypertrophic Cardiomyopathy with High Risk Criteria as Defined by the Guidelines; 2. Arrhythmogenic RV Dysplasia/Cardiomyopathy with High Risk Criteria as Defined by the Guidelines; 3. Long QT Syndrome refractory to beta blocker therapy with recurrent syncope or ventricular tachycardia/fibrillation; 4. Catecholamine polymorphic ventricular tachycardia.

Secondary Prevention Defibrillator should document any strips of arrhythmias and proof that the cause was not reversible (ie drug induced or due to severe electrolyte abnormalities). Labs from the time of the arrhythmia should be submitted to prove the later along with medical history and associated medications. Documentation and proof that any sustained ventricular tachycardia or ventricular fibrillation prompting a secondary defibrillator did not occur in the setting of an acute myocardial infarction (troponins and source analysis/assessment/and documentation should be provided). In addition, any and all non-sustained ventricular tachycardia should also occur in a nonreversible setting at least 48 hours (but preferable at least 96 hours) outside of an acute myocardial infarction, coronary bypass surgery or percutaneous coronary intervention and have stable electrolytes and not be drug induced (ie nonreversible cause). Documentation of true syncope and a need for electrophysiology testing should also be uploaded along with the results of such testing including proof of ventricular tachycardia induction via source material.

Upload Source Material From any Electrophysiology Study including report and actual intracardiac recordings which demonstrates the method of induction of the ventricular tachycardia, its cycle length, duration, hemodynamic consequence, mA and pulse width during induction (visual record should be provided), and mode of termination. Specificity (ie sustained monomorphic ventricular tachycardia at cycle lengths greater than or equal to 200 ms) and when necessary reproducibility (especially for easily inducible polymorphic ventricular tachycardia) should be documented.

Upload Source Material Supporting the Patients Left Ventricular Ejection Fraction: Actual Independent Reports of Any Echocardiograms, Nuclear Studies, CT Angiography, Cardiac Catheterization Procedures, and Cardiac MRIs within a 6 month period must be submitted.

Documentation as with the Pacing Criteria for a Second lead should be provided up front except if ventricular pacing results in at least a 20 mmHg systolic drop in blood pressure, in which case Strips and actual blood pressures must be provided;—the latter could be performed and entered during an approved defibrillator implant procedure.

Upload source interrogation data documenting existing systems malfunction, end of life status, patient's need for replacement/revision, and if upgrade is indicated any and all pacemaker source documentation that would qualify the patient for an additional lead and/or cardiac resynchronization therapy should be provided. The latter should follow any Local Coverage Determination and if none exist, that of the Heart Rhythm Society's Guidelines.

Please provide a description of any extenuating circumstances that explain the rationale for the specific request.

Upload said data and the operator needs to certify the request for the release of said implantable pacemaker implantable material.

Once all data is entered, and the implant type is requested, it is formerly submitted for evaluation via computerized and/or human approval process.

If approved, a secure method for release of the implant materials will be provided.

Borderline/Questionable Cases:

This system will provide a method for adjudicating borderline/questionable cases in a timely fashion.

Pacemaker cases may require additional prolonged monitoring (event or loop recorder), which may be recommended after this submission.

Defibrillator cases may require a wearable cardioverter-defibrillator and additional monitoring and/or testing, which may be recommended after this submission.

The services medical director or equivalent could also me contacted and the case discussed in detail in order to resolve the doctor and patient's next course of action.

A method is also provided for using patient specific bar codes or data matrix codes or some other secure code and linking source data to that code prior to approval. In addition, said code could also be used after approval, and following the procedure to track any and all complications related to said implant. The latter would be useful at quantifying operator and institution outcomes for a process called value based purchasing. The latter is useful at negotiating provider rates based on outcomes. The bar codes or data matrix codes or some other code could integrate implant product information with patient specific information and be tracked regardless of institution. In addition, this way of codifying patient specific data together with implant data in a centralized or cloud based database or system would be equally as useful for tracking the performance of implant products. A similar source data method is also provided for acquiring source data demonstrating lead or device failure which could be automatically uploaded to the Maude Database (a failure based database) and submitted to the Food and Drug Administration as well as the original Manufacturer to determine whether any warranty information applies as well as to determine any trends in implantable equipment failure that might signal a safety advisory or a Recall. In addition, said data would be used in determining whether the failure of said implant is covered by a manufacturer's warranty (in part or in full) and assuring that a hospital or institution does not get paid by both insurance and the manufacturer for the same service (ie double dipping) and would assure an institution's compliance with respect to warranty coverage and payment.

In essence, a complete and private and secure implantable product/performance (operator/institution/and product) management system is provided using data which could be scanned (bar codes, data matrix codes, and the like) and provides for uploading source data each step of the way. Said system could also assure that the product is not expired prior to implant (at the time of initial approval/release) and/not under safety advisory or Recall at that time. Implant and post implant operator and product failures are also quantifiable and most importantly said system can provide outcomes data with respect to the operator, institution, and implanted material. Finally, said system could provide oversight protection in order to make an institution compliant and less likely to violate and rules or regulations.

### EXAMPLE

Patient is 65 year old man with history of myocardial infarction 6 months ago and documented ejection fraction of 25% and is referred for implantable defibrillator.

Source documentation would need to be securely submitted either directly or indirectly to a system or service which rapidly evaluate the data and determine whether appropriate criteria exists for approval and release of an implantable device/products consistent with the approval process. The device could be released via either a service which would bring it to a facility or a secure vending-type machine according to the invention and could be performed relatively quickly. Source data would include:

Patient's Name

Date of Birth

Precise Indication Criteria documented by primary source material proving that the regulatory criteria (such as a National Coverage Determination) are met.

Ie—Proof of EF less than or equal to 30% within the past month (echo report inserted/scanned/or electrically submitted)

Proof of no myocardial infraction within 40 days and no coronary artery
bypass surgery or percutaneous coronary intervention within 3 months
(parenthesis data submitted as above). Patient's data matrix and/or bar code could be scanned along with the source data.

Submitting Doctor and Provider Number

All of the above must be submitted prior to approval and release of said specific and qualified implantable device products.

The materials would be submitted (and perhaps even reviewed by an automated process or an independent human third party), and the desired implantable medical product could be released or denied). The system would also provide a method for requesting additional data if inadequate data was submitted. For cardiac rhythm products such as an implantable defibrillator, a wearable cardioverter-defibrillator could be approved by said system in order to provide patient protection during a more protracted and/or controversial implant decision while safely protecting the patient.

It is within the scope of the invention that materials to be submitted such as bar codes, data, matrix codes, and other coding systems can be scanned and submitted through smart phones, tablets, iPads, notebooks, computers, scanners, cameras, netbooks, and the like. Computer, smart phone/tablet, notebook, netbook or the like applications (such as iPhone Apps) could be utilized to upload data in a similar fashion as Chase bank uploads checks using a smart phone App and camera. Apps such as RedLaser (a smart phone bar code/data matrix scanning App) as well as a novel newly designed App could be used to upload data to a centralized place such as a net server or Cloud computing center to store and organize this information.

Approval of a particular product would permit lead selection and device selection and dispensing from said machine or actual release directly by a regulatory agency, insurance company, health system, or manufacturer/vendor.

The algorithm for approval could operate on a standard PC, laptop, notebook, tablet, smart phone, secure server, or even access a secure cloud computing system where an algorithm will be provided which will evaluate the criteria set by a regulatory body (defined as anybody that controls and manages health care). Such a regulatory body may include one or more of the above (CMS, Medicaid, Managed Care/Insurance Companies, and/or the societies that set the guidelines). The criteria must include actual source material submitted in total to qualify for the precise implantable product (pacemaker, implantable defibrillator, cardiac synchronization device. Additional medical certification via the physician and/or medical team may be required to authorize the approval.

Confidential source data will be submitted via a secure method to the service either digitally, scanned, as an attachment, etc.

Source material may include actual electrocardiogram/holter monitor strips of the arrhythmias (ventricular tachycardia/ventricular fibrillation/bradycardia/pauses/asystole and concurrent documented symptoms), recent evaluation of left ventricular function (within a preset time frame), recent evaluation of ischemia (within a preset time frame) either by stress echo, nuclear study, stress test, or cardiac catheterization, proof of no myocardial infarction, bypass surgery or percutaneous coronary intervention (within preset time frames), proof that the arrhythmias were not of a reversible cause (i.e., the labs being within normal limits and no bump in troponin within 24 hrs.), proof of the existence of a chronic congestive heart failure and the treatment of it with optimal medical therapy over a preset time frame as reflected in the medical records (typically at least three months), correlation of significant bradycardia with symptoms, documentation of complete heart block or Mobitz type 2 second degree AV block. The results of an electrophysiology study and copies of intracardiac recordings demonstrating the necessity for a dual chamber device (4 CMS criteria—1. Young and Active, 2. Congestive heart failure, 3. Pacemaker syndrome, 4. Drop in systolic blood pressure of at least 20 mmHg during ventricular pacing—the latter may need to be demonstrated and certified during the case to release a dual chamber lead product) and copies of any inducible arrhythmia and certification of how it was induced and treated and establishment of whether it was sustained or non-sustained by current definition as established by the NCDR. Copies of the mA and pulse width as well as the induction method may be required along with the precise image of the full induced arrhythmia as well as its treatment (defibrillation).

An example of source data required for approval and release of data comes directly from the Center for Medicare Services (CMS) and their National Coverage Determination as obtained from their website. What follows is their specific requirements for implantable pacemakers and implantable cardioverter-defibrillators. Upfront source data and operator/institutional certification would be required in order to release said products to the implanter via the methods described herein. What follows are the two National Coverage Determinations in total as obtained from the CMS websites.

### APPENDIX

### The Following are Directly Taken from the CMS Website and List the National Coverage Determination for Implantable Defibrillators and Pacemakers

### National Coverage Determination (NCD) for Implantable Defibrillators

### Benefit Category

### Prosthetic Devices

Note: This may not be an exhaustive list of all applicable Medicare benefit categories for this item or service.

### Item/Service Description

### A. General

The implantable automatic defibrillator is an electronic device designed to detect and treat life-threatening tachyarrhythmias. The device consists of a pulse generator and electrodes for sensing and defibrillating.

### Indications and Limitations of Coverage

### B. Covered Indications

1. Documented episode of cardiac arrest due to ventricular fibrillation (VP), not due to a transient or reversible cause (effective Jul. 1, 1991).
2. Documented sustained ventricular tachyarrhythmia (VT), either spontaneous or induced by an electrophysiology (EP) study, not associated with an acute myocardial infarction (MI) and not due to a transient or reversible cause (effective Jul. 1, 1999).
3. Documented familial or inherited conditions with a high risk of life-threatening VT, such as long QT syndrome or hypertrophic cardiomyopathy (effective Jul. 1, 1999). Additional indications effective for services performed on or after Oct. 1, 2003:
4. Coronary artery disease with a documented prior MI, a measured left ventricular ejection fraction (LVEF) ≦0.35, and inducible, sustained VT or VF at EP study. (The MI must have occurred more than 40 days prior to defibrillator insertion. The EP test must be performed more than 4 weeks after the qualifying MI.)
5. Documented prior MI and a measured LVEF ≦0.30 and a QRS duration of >120 milliseconds (the QRS restriction does not apply to services performed on or after Jan. 27, 2005). Patients must not have:
a. New York Heart Association (NYHC) classification IV;
b. Cardiogenic shock or symptomatic hypotension while in a stable baseline rhythm;
c. Had a coronary artery bypass graft (CABG) or percutaneous transluminal coronary angioplasty (PTCA) within past 3 months;
d. Had an enzyme positive MI within past month (Effective for services on or after Jan. 27, 2005, patients must not have an acute MI in the past 40 days);
e. Clinical symptoms or findings that would make them a candidate for coronary revascularization; or
f. Any disease, other than cardiac disease (e.g., cancer, uremia, liver failure), associated with a likelihood of survival less than 1 year.
   6. Additional indications effective for services performed on or after Jan. 27, 2005:
   7. Patients with ischemic dilated cardiomyopathy (IDCM), documented prior MI, NYHA Class II and III heart failure, and measured LVEF ≦35%;
   8. Patients with non-ischemic dilated cardiomyopathy (NIDCM) >9 months, NYHA Class II and III heart failure, and measured LVEF ≦35%;
   9. Patients who meet all current Centers for Medicare & Medicaid Services (CMS) coverage requirements for a cardiac resynchronization therapy (CRT) device and have NYHA Class IV heart failure; All indications must meet the following criteria:
a. Patients must not have irreversible brain damage from preexisting cerebral disease;
b. MIs must be documented and defined according to the consensus document of the Joint European Society of Cardiology/American College of Cardiology Committee for the Redefinition of Myocardial Infarction; 1
   10. Indications 3-8 (primary prevention of sudden cardiac death) must also meet the following criteria:
a. Patients must be able to give informed consent;
b. Patients must not have:
   Cardiogenic shock or symptomatic hypotension while in a stable baseline rhythm;
   Had a CABG or PTCA within the past 3 months;
   Had an acute MI within the past 40 days;
   Clinical symptoms or findings that would make them a candidate for coronary revascularization;
   Any disease, other than cardiac disease (e.g., cancer, uremia, liver failure), associated with a likelihood of survival less than 1 year;
d. Ejection fractions must be measured by angiography, radionuclide scanning, or echocardiography;
e. The beneficiary receiving the defibrillator implantation for primary prevention is enrolled in either a Food and Drug Administration (FDA)-approved category B investigational device exemption (IDE) clinical trial (42 CFR §405.201), a trial under the CMS Clinical Trial Policy (National Coverage Determination (NCD) Manual §310.1) or a qualifying data collection system including approved clinical trials and registries. Initially, an implantable cardiac defibrillator (ICD) database will be maintained using a data submission mechanism that is already in use by Medicare participating hospitals to submit data to the Iowa Foundation for Medical Care (IFMC) a Quality Improvement Organization (QIO) contractor for determination of reasonable and necessary and quality improvement. Initial hypothesis and data elements are specified in this decision (Appendix VI) and are the minimum necessary to ensure that the device is reasonable and necessary. Data collection will be completed using the ICDA (ICD Abstraction Tool) and transmitted via QNet (Quality Network Exchange) to the IFMC who will collect and maintain the database. Additional stakeholder-developed data collection systems to augment or replace the initial QNet system, addressing at a minimum the hypotheses specified in this decision, must meet the following basic criteria:
   Written protocol on file;
   Institutional review board review and approval;
   Scientific review and approval by two or more qualified
   individuals who are not part of the research team;
   Certification that investigators have not been disqualified.
f. For purposes of this coverage decision, CMS will determine whether specific registries or clinical trials meet these criteria.
g. Providers must be able to justify the medical necessity of devices other than single lead devices. This justification should be available in the patient's medical record.
   11.
   12. Patients with NIDCM >3 months, NYHA Class II or III heart failure, and measured LVEF ≦35%, only if the following additional criteria are also met:
a. Patients must be able to give informed consent;
b. Patients must not have:
   Cardiogenic shock or symptomatic hypotension while in a stable baseline rhythm;
   Had a CABG or PTCA within the past 3 months;
   Had an acute MI within the past 40 days;
   Clinical symptoms or findings that would make them a candidate for coronary revascularization;
   Irreversible brain damage from preexisting cerebral disease;
   Any disease, other than cardiac disease (e.g. cancer, uremia, liver failure), associated with a likelihood of survival less than 1 year;
c. Ejection fractions must be measured by angiography, radionuclide scanning, or echocardiography;
d. MIs must be documented and defined according to the consensus document of the Joint European Society of Cardiology/American College of Cardiology Committee for the Redefinition of Myocardial Infarction; 2
e. The beneficiary receiving the defibrillator implantation for this indication is enrolled in either an FDA-approved category B IDE clinical trial (42 CFR §405.201), a trial under the CMS Clinical Trial Policy (NCD Manual §310.1), or a prospective data collection system meeting the following basic criteria:
   Written protocol on file;
   Institutional Review Board review and approval;
   Scientific review and approval by two or more qualified individuals who are not part of the research team;
   Certification that investigators have not been disqualified.
f. For purposes of this coverage decision, CMS will determine whether specific registries or clinical trials meet these criteria.
g. Providers must be able to justify the medical necessity of devices other than single lead devices, This justification should be available in the patient's medical record,

### C. Other Indications

All other indications for implantable automatic defibrillators not currently covered in accordance with this decision will continue to be covered under Category B IDE trials (42 CFR §405.201) and the CMS routine clinical trials policy (NCD §310.1).

(This NCD last reviewed February 2005.)

1 Alpert and Thygesen et al., 2000. Criteria for acute, evolving or recent MI.
Either one of the following criteria satisfies the diagnosis for an acute, evolving or recent MI:
1. Typical rise and gradual fall (troponin) or more rapid rise and fall (CK-MB) of biochemical markers of myocardial necrosis with at least one of the following:
a. ischemic symptoms;
b. development of pathologic Q waves on the ECG;
c. ECG changes indicative of ischemia (ST segment elevation or depression); or
d. coronary artery intervention (e.g., coronary angioplasty).
   2. Pathologic findings of an acute MI.
   Criteria for established MI.
   Any one of the following criteria satisfies the diagnosis for established MI:
   1. Development of new pathologic Q waves on serial ECGs. The patient may or may not remember previous symptoms. Biochemical markers of myocardial necrosis may have normalized, depending on the length of time that has passed since the infarct developed.
   2. Pathologic findings of a heated or healing MI.

### ² Ibid

### Claims Processing Instructions

### TN 497 (Medicare Claims Processing Manual)

### Transmittal Information

### Transmittal Number

29
Coverage Transmittal link
http://www.cms.gov/transmittals/downloads/R29NCD.pdf
January 1986—Provided coverage to treat life-threatening ventricular tachyarrhythmias. Effective date Jan. 24, 1986. (TN 3)
April 1999—Expanded coverage for additional types of cardiac patients. Effective and implementation dates Jul. 1, 1999. (TN 115) (CR 825)
August 2003—Expanded coverage for coronary artery disease with a documented prior myocardial infarction (MI), a measured left ventricular ejection fraction ≦0.35, and inducible, sustained ventricular tachyarrhythmia or ventricular fibrillation at electrophysiology study; or documented prior MI and a measured left ventricular ejection fraction ≦0.30 and a QRS duration of >120 milliseconds. All other indications for defibrillators not otherwise specified remain noncovered except when furnished in accordance with FDA-approved protocols governing Category B Investigational Device Exemption; clinical trials as stated in 42 FR Part 405. Effective and implementation dates Oct. 1, 2003. (TN 173) (CR 2880)
March 2005—Expanded national coverage by including new indications. Effective and implementation dates Jan. 27, 2005, (TN 29) (CR 3604)

### National Coverage Determination (NCD) for Cardiac Pacemakers (20.8)

13. Expand All—All sections on the page are Expanded Collapse All

### Publication Number

100-3

### Manual Section Number

20.8

### Manual Section Title

### Cardiac Pacemakers

### Version Number

2
Effective Date of this Version

### Apr. 30, 2004

### Implementation Date

### Apr. 30, 2004

### Benefit Category

### Inpatient Hospital Services

### Physicians' Services

### Prosthetic Devices

Note: This may not be an exhaustive list of all applicable Medicare benefit categories for this item or service.

### Item/Service Description

Cardiac pacemakers are self-contained, battery-operated units that send electrical stimulation to the heart. They are generally implanted to alleviate symptoms of decreased cardiac output related to abnormal heart rate and/or rhythm. Pacemakers are generally used for persistent, symptomatic second- or third-degree atrioventricular (AV) block and symptomatic sinus bradycardia.

### Indications and Limitations of Coverage

Cardiac pacemakers are covered as prosthetic devices under the Medicare program, subject to the following conditions and limitations. While cardiac pacemakers have been covered under Medicare for many years, there were no specific guidelines for their use other than the general Medicare requirement that covered services be reasonable and necessary for the treatment of the condition. Services rendered for cardiac pacing on or after the effective dates of this instruction are subject to these guidelines, which are based on certain assumptions regarding the clinical goals of cardiac pacing. While some uses of pacemakers are relatively certain or unambiguous, many other uses require considerable expertise and judgment.

Consequently, the medical necessity for permanent cardiac pacing must be viewed in the context of overall patient management. The appropriateness of such pacing may be conditional on other diagnostic or therapeutic modalities having been undertaken, Although significant complications and adverse side effects of pacemaker use are relatively rare, they cannot be ignored when considering the use of pacemakers for dubious medical conditions, or marginal clinical benefit.

These guidelines represent current concepts regarding medical circumstances in which permanent cardiac pacing may be appropriate or necessary. As with other areas of medicine, advances in knowledge and techniques in cardiology are expected. Consequently, judgments about the medical necessity and acceptability of new uses for cardiac pacing in new classes of patients may change as more conclusive evidence becomes available. This instruction applies only to permanent cardiac pacemakers, and does not address the use of temporary, non-implanted pacemakers.

The two groups of conditions outlined below deal with the necessity for cardiac pacing for patients in general. These are intended as guidelines in assessing the medical necessity for pacing therapies, taking into account the particular circumstances in each case. However, as a general rule, the two groups of current medical concepts may be viewed as representing:

Group I: Single-Chamber Cardiac Pacemakers—a) conditions under which single chamber pacemaker claims may be considered covered without further claims development; and b) conditions under which single-chamber pacemaker claims would be denied unless further claims development shows that they fall into the covered category, or special medical circumstances exist of the sufficiency to convince the contractor that the claim should be paid.

Group II: Dual-Chamber Cardiac Pacemakers—a) conditions under which dual-chamber pacemaker claims may be considered covered without further claims development, and b) conditions under which dual-chamber pacemaker claims would be denied unless further claims development shows that they fall into the covered categories for single- and dual-chamber pacemakers, or special medical circumstances exist sufficient to convince the contractor that the claim should be paid.

CMS opened the NCD on Cardiac Pacemakers to afford the public an opportunity to comment on the proposal to revise the language contained in the instruction. The revisions transfer the focus of the NCD from the actual pacemaker implantation procedure itself to the reasonable and necessary medical indications that justify cardiac pacing. This is consistent with our findings that pacemaker implantation is no longer considered routinely harmful or an experimental procedure.

Group I: Single-Chamber Cardiac Pacemakers (Effective Mar. 16, 1983)

h. Nationally Covered Indications

Conditions under which cardiac pacing is generally considered acceptable or necessary, provided that the conditions are chronic or recurrent and not due to transient causes such as acute myocardial infarction, drug toxicity, or electrolyte imbalance. (In cases where there is a rhythm disturbance, if the rhythm disturbance is chronic or recurrent, a single episode of a symptom such as syncope or seizure is adequate to establish medical necessity.)

Acquired complete (also referred to as third-degree) AV heart block.

Congenital complete heart block with severe bradycardia (in relation to age), or significant physiological deficits or significant symptoms due to the bradycardia.

Second-degree AV heart block of Type II (i.e., no progressive prolongation of P-R interval prior to each blocked beat. P-R interval indicates the time taken for an impulse to travel from the atria to the ventricles on an electrocardiogram).

Second-degree AV heart block of Type I (i.e., progressive prolongation of P-R interval prior to each blocked beat) with significant symptoms due to hemodynamic instability associated with the heart block.

Sinus bradycardia associated with major symptoms (e.g., syncope, seizures, congestive heart failure); or substantial sinus bradycardia (heart rate less than 50) associated with dizziness or confusion. The correlation between symptoms and bradycardia must be documented, or the symptoms must be clearly attributable to the bradycardia rather than to some other cause.

In selected and few patients, sinus bradycardia of lesser severity (heart rate 50-59) with dizziness or confusion. The correlation between symptoms and bradycardia must be documented, or the symptoms must be clearly attributable to the bradycardia rather than to some other cause.

Sinus bradycardia is the consequence of long-term necessary drug treatment for which there is no acceptable alternative when accompanied by significant symptoms (e.g., syncope, seizures, congestive heart failure, dizziness or confusion). The correlation between symptoms and bradycardia must be documented, or the symptoms must be clearly attributable to the bradycardia rather than to some other cause.

Sinus node dysfunction with or without tachyarrhythmias or AV conduction block (i.e., the bradycardia-tachycardia syndrome, sino-atrial block, sinus arrest) when accompanied by significant symptoms (e.g., syncope, seizures, congestive heart failure, dizziness or confusion).

Sinus node dysfunction with or without symptoms when there are potentially life-threatening ventricular arrhythmias or tachycardia secondary to the bradycardia (e.g., numerous premature ventricular contractions, couplets, runs of premature ventricular contractions, or ventricular tachycardia).

Bradycardia associated with supraventricular tachycardia (e.g., atrial fibrillation, atrial flutter, or paroxysmal atrial tachycardia) with high-degree AV block which is unresponsive to appropriate pharmacological management and when the bradycardia is associated with significant symptoms (e.g., syncope, seizures, congestive heart failure, dizziness or confusion).

The occasional patient with hypersensitive carotid sinus syndrome with syncope due to bradycardia and unresponsive to prophylactic medical measures.

Bifascicular or trifascicular block accompanied by syncope which is attributed to transient complete heart block after other plausible causes of syncope have been reasonably excluded.

Prophylactic pacemaker use following recovery from acute myocardial infarction during which there was temporary complete (third-degree) and/or Mobitz Type II second-degree AV block in association with bundle branch block.

In patients with recurrent and refractory ventricular tachycardia, “overdrive pacing” (pacing above the basal rate) to prevent ventricular tachycardia.

(Effective May 9, 1985)

Second-degree AV heart block of Type I with the QRS complexes prolonged.

B. Nationally Noncovered Indications

Conditions which, although used by some physicians as a basis for permanent cardiac pacing, are considered unsupported by adequate evidence of benefit and therefore should not generally be considered appropriate uses for single-chamber pacemakers in the absence of the above indications. Contractors should review claims for pacemakers with these indications to determine the need for further claims development prior to denying the claim, since additional claims development may be required. The object of such further development is to establish whether the particular claim actually meets the conditions in a) above. in claims where this is not the case or where such an event appears unlikely, the contractor may deny the claim

Syncope of undetermined cause.

Sinus bradycardia without significant symptoms.

Sino-atrial block or sinus arrest without significant symptoms.

Prolonged P-R intervals with atrial fibrillation (without third-degree AV block) or with other causes of transient ventricular pause.

Bradycardia during sleep.

Right bundle branch block with left axis deviation (and other forms of fascicular or bundle branch block) without syncope or other symptoms of intermittent AV block).

Asymptomatic second-degree AV block of Type I unless the QRS complexes are prolonged or electrophysiological studies have demonstrated that the block is at or beyond the level of the His bundle (a component of the electrical conduction system of the heart).

Effective Oct. 1, 2001

Asymptomatic bradycardia in post-mycardial infarction patients about to initiate long-term beta-blocker drug therapy.

a. C. Other

All other indications for single-chamber cardiac pacing for which CMS has not specifically indicated coverage remain nationally non-covered, except for Category B Investigational Device Exemption (IDE) clinical trials, or as routine costs of single-chamber cardiac pacing associated with clinical trials, in accordance with section 310.1 of the NCD Manual.

Group II: Dual-Chamber Cardiac Pacemakers—(Effective May 9, 1985)

a. Nationally Covered Indications
b. Conditions under dual-chamber cardiac pacing are considered acceptable or necessary in the general medical community unless conditions 1 and 2 under Group II. B., are present:

Patients in who single-chamber (ventricular pacing) at the time of pacemaker insertion elicits a definite drop in blood pressure, retrograde conduction, or discomfort.

Patients in whom the pacemaker syndrome (atrial ventricular asynchrony), with significant symptoms, has already been experienced with a pacemaker that is being replaced.

Patients in whom even a relatively small increase in cardiac efficiency will importantly improve the quality of life, e.g., patients with congestive heart failure despite adequate other medical measures.

Patients in whom the pacemaker syndrome can be anticipated, e.g., in young and active people, etc.

Dual-chamber pacemakers may also be covered for the conditions, as listed in Group I. A., if the medical necessity is sufficiently justified through adequate claims development. Expert physicians differ in their judgments about what constitutes appropriate criteria for dual-chamber pacemaker use. The judgment that such a pacemaker is warranted in the patient meeting accepted criteria must be based upon the individual needs and characteristics of that patient, weighing the magnitude and likelihood of anticipated benefits against the magnitude and likelihood of disadvantages to the patient.

B. Nationally Non-Covered Indications

Whenever the following conditions (which represent overriding contraindications) are present, dual-chamber pacemakers are not covered:

Ineffective atrial contractions (e.g., chronic atrial fibrillation or flutter, or giant left atrium.

Frequent or persistent supraventricular tachycardias, except where the pacemaker is specifically for the control of the tachycardia.

A clinical condition in which pacing takes place only intermittently and briefly, and which is not associated with a reasonable likelihood that pacing needs will become prolonged, e.g., the occasional patient with hypersensitive carotid sinus syndrome with syncope due to bradycardia and unresponsive to prophylactic medical measures.

Prophylactic pacemaker use following recovery from acute myocardial infarction during which there was temporary complete (third-degree) and/or Type II second-degree AV block in association with bundle branch block.

C. Other

All other indications for dual-chamber cardiac pacing for which CMS has not specifically indicated coverage remain nationally non-covered, except for Category B IDE clinical trials, or as routine costs of dual-chamber cardiac pacing associated with clinical trials, in accordance with section 310.1 of the NCD Manual.

(This NCD last reviewed June 2004.)

1-32. (canceled)

33. A method for assuring compliance with respect to the current and/or revised and/or updated National Coverage Determination implantation indication criteria for implantable medical devices such as pacemakers and defibrillators, as issued by the Center for Medicare Service, comprising
inputting demographic data for a patient into a computerized system or processor for enrolling and tracking each subscribed institution and each implanting operator or provider to enroll the patient with regard to possible implantation of an implantable medical device;
quantifying each National Coverage Determination implantation indication into preset source document baskets, each of which entirely satisfies one of the National Coverage Determination implantation indication criteria;
uploading source data documents and storing said documents in each basket for review and compliance approval prior to said possible implantation;
independently reviewing and evaluating source documents in said baskets and determining whether each source document meets corresponding implantation indication criteria as determined by the National Coverage Determination;
approving or disproving a proposed implantation as meeting all of said implantation indication criteria and submitting said approval for secure release of an implantable medical device for the patient; and
generating a secure code for release of said implantable medical device for the approved implantation procedure.

34. The method of claim 33 which comprises an additional step of keeping implantable medical devices a large storage system with secure access for systematic release of said implantable medical devices based on a secure generated access code.

35. The method of claim 33, wherein the source data comprise a consent form attesting to the fact that the patient signed his or her own consent, and documentation to the effect that the patient has an expected longevity greater than one year

36. The method of claim 33, wherein the source data comprise one or more criteria selected from the group consisting of electrocardiograms, left ventricular ejection fraction reports, laboratory results proving irreversible cause of the arrhythmia, electrocardiographic strips and electrophysiology reports, and history/progress notes/consults.

37. The method of claim 33, wherein the source data required for said basket for an implantable defibrillator approval includes those specified by the current and/or revised and/or updated National Coverage Determination and optionally criteria which documents that the device is to be implanted for primary prevention and would be implanted more than 40 days after a myocardial infarction and/or more than 90 days after a revascularization procedure such as coronary artery bypass grafting surgery or percutaneous coronary intervention.

38. The method of claim 37, wherein the criteria includes another related or updated timing interval.

39. The method of claim 33, wherein, for secondary prevention, said source data required for said basket would establish that the patient meets certain timing intervals related to the performance and results of an electrophysiology study, all related electrocardiographic strips and induced and qualifying arrhythmias.

40. The method of claim 33, wherein, based on a particular National Coverage Determination implantation indication criteria, source documentation would be required to establish for primary prevention: the presence of congestive heart failure, a required duration of congestive heart failure in order to establish that the condition itself is chronic rather than acute in nature (including optimal medical treatment time period), and documentation to assure that the patient has the appropriately documented qualifying New York Heart Association congestive heart failure classification category that is required for a specified implantation.

41. The method of claim 33, wherein source data would be required to establish that the patient has a significant familial sudden death syndrome or condition requiring a defibrillator, or to establish that the patient meets the criteria for cardiac resynchronization therapy.

42. The method of claim 33, wherein the source data required for a basket for an implantable pacemaker approval includes those specified by the current and/or revised and/or updated National Coverage Determination implantation indication criteria and includes criteria which document a correlation between the patient's rhythm abnormality and symptoms, any documented qualifying electrocardiographic or electrophysiology reports and strips, the necessity for pacing to prevent ventricular arrhythmias (if that is the indication), and that the patient meets criteria for cardiac resynchronization therapy (if that is the indication).

43. The method of claim 42, wherein the source data required for a second pacemaker lead meets current and/or revised criteria as established by the National Coverage Determination implantation indication criteria for pacemaker implantation.

44. The method of claim 33 which also includes a procedure for adjudicating cases that fail to satisfy the National Coverage Determination implantation indication criteria.

45. The method of claim 33 which also includes a procedure for authorizing use of a wearable cardioverter defibrillator to protect a patient from sudden death during adjudication of a case that does not readily meet the National Coverage Determination implantation criteria.

46. The method of claim 33 which also comprises long-term storage of said data in case of an audit by Medicare, Medicaid, a health insurance company, or some other reviewing body.

47. The method of claim 33 which is used by the federal government as a cost containment measure by controlling use of an expensive implantable medical device in a health system with limited resources.

48. The method of claim 33 which is used by an institution as a compliance tool to prevent exposure of the institution to fraud and/or abuse.

49. The method of claim 33 which is coupled to a liability umbrella coverage to minimize institutional exposure to fraud and/or abuse.

50. The method of claim 33 in which an authorized institutional administrator has the ability to override the decision of a reviewer to approve an implantable medical device and to generate a secure code for release of the implantable medical device for the safety of the patient without billing Medicare or Medicaid or any associated health insurance.

51. The method of claim 33, wherein any quantifiable fields, such as demographic and/or source documents, can be linked to the National Coverage Determination Registry as they relate to relevant implantable products.

52. The method of claim 33, wherein actual source data is submitted via mail, electronically, digitally, scanned, or via some other means and evaluated and approved via either a computerized means and/or human means and based on said data an approval is generated either directly or indirectly to provide for the release of implantable medical devices to be available for said procedure.

53. The system of claim 33, wherein the review and evaluation is computerized and performed in a cloud with human oversight.

54. The method of claim 53 which is performed entirely with human oversight.

55. The method of claim 33 in which the data would be useful at quantifying an individual and/or medical institution/health systems outcomes for value-based purchasing.

56. The method of claim 33 as it relates to securely protecting a medical institution with respect to compliance as it relates to the appropriateness of medical implants, tracking any device and or operator failure, providing outcomes data that are implant product related (types of failure modes), operator related (such as number and types of procedures and specific complications), and/or institution related (such as number and types of procedures and specific complications), and assuring that any warranty payments are appropriate based on state and federal requirements.

57. The method of claim 33, wherein an institutional administrator can override the results of a non-approved review and approve implantation of an implantable medical device for the safety of the patient.

58. The method of claim 57, wherein the implantable medical device is either a pacemaker or a defibrillator.

59. The method of claim 57, wherein the override would not result in a hospital or physician bill to the center for Medicare and Medicaid services for compliance purposes.

60. A system for assuring compliance with respect to the National Coverage Determination implantation indication criteria for implantable medical devices such as pacemakers and defibrillators as issued by the Center for Medicare and Medicaid Services, comprising
a computerized system or processor for enrolling and tracking each subscribed institution and each implanting operator or provider;
a source of demographic data to be inputted to enroll each patient proposed for an implantation;
means for quantifying each National Coverage Determination implantation indication criteria into preset source document baskets, each of which entirely satisfies one of the National Coverage Determination implantation indication criteria;
means for uploading said source data to the computerized system or processor to store said documents into said baskets for review and compliance approval prior to said implantation;
means to independently review and evaluate said baskets and determine whether the source documents meet the National Coverage Determination implantation indication criteria;
means for a reviewer to approve or disprove said implantation as meeting all of the implantation indication criteria and to submit said approval for secure release of an implantable medical device for the patient; and
means to generate as secure code for release of said implantable medical device for the approved implantation procedure.

61. The system of claim 60 which also comprises a large storage system for systematically keeping implantable medical products with secure access and release of said implantable medical products based on the secure generated access code.

62. The system of claim 60 which also comprises means to provide a wearable cardioverter defibrillator to protect a patient from sudden death while adjudicating cases that do not readily meet the National Coverage Determination implantation indication criteria.

63. The system of claim 60 which also comprises long-term storage of said data in case of an audit by Medicare, Medicaid, a health insurance company, or some other reviewing body.

64. The system of claim 60 winch is coupled to a liability umbrella coverage to minimize institutional exposure to fraud and/or abuse.

65. The system of claim 60, wherein any quantifiable fields can be linked to the National Coverage Determination Registry as they relate to relevant implantable devices.

66. A method for ensuring compliance with guidelines and/or appropriate use criteria as set by national and/or international societies and also in compliance with their geographic governmental regulatory agency or agencies regarding the appropriate implantation of implantable medical devices, which comprises:
uploading source documentation through a computerized system to a third party evaluation;
comparing said source documentation with criteria established by national and/or international societies and their geographic governmental regulatory bodies in order to determine whether or not there has been compliance; and
issuing approval documentation if there has been compliance.

67. The method of claim 66, wherein the approval provides a method for release of said equipment from a secure machine having implantable medical devices to dispense and charge the patient accordingly.

68. The method of claim 66, wherein the approval provides a method for release of said implantable medical devices from a secure service such as the government, third party, health insurance companies, hospital/medical system, or manufacturer having implantable products to dispense and charge the patient accordingly.

69. The method of claim 66, wherein a ticket and/or secure method of accessing the secure implantable medical device, once approved, is provided and once the secure method is entered into said system, the implantable medical device is released.

70. The method of claim 66 which is a service provided by the government, a third party such as a health insurance comply, hospital/medical system, or manufacturer which actually holds and/or controls the release of said products.

71. A system for ensuring compliance with National Coverage Determination implantation indication criteria regarding the implantation of implantable medical devices, which comprises:
means to upload source documentation through a computerized system to a third party evaluation;
means to compare said source documentation with criteria established by the National Coverage Determination Registry to determine whether or not there has been compliance; and
means to issue approval documentation if there has been compliance.

72. The system of claim 71 which includes means to release said implantable medical device from a secure machine having implantable medical devices to dispense and to charge the patient accordingly.

73. The system of claim 71, winch comprises means upon approval to release said implantable medical device from a secure service such as the government, third party, health insurance companies, hospital/medical system, or manufacturer having implantable medical devices to dispense and to charge the patient accordingly.
